(19) United States
(12) Patent Application Publication
(10) Pub. No.: US 2026/0303276 A1
(43) Pub. Date: Oct. 1, 2026

(54) TECHNIQUES TO FACILITATE A DEFAULT UNIFIED TCI FOR DYNAMIC TRP SWITCHING IN MULTIPLE TRP OPERATION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/880,265

(22) PCT Filed: Aug. 29, 2022
(86) PCT No.: PCT/CN2022/115431

§ 371 Date: Dec. 30, 2024

(51) Int. Cl. H04L 5/00; H04W 72/232

(52) U.S. Cl. CPC H04L 5/0035; H04L 5/0094; H04L 5/0096; H04W 72/232

(57) ABSTRACT

Apparatus, methods, and computer-readable media for facilitating a default unified TCI rule for periodic or semi-periodic communications after performing a TRP operation mode switch between mTRP operation and sTRP operation are disclosed herein. An example method for wireless communication at a UE includes receiving a configuration configuring a plurality of TCI codepoints. The example method also includes receiving a first indication indicating a first TCI codepoint. The example method also includes communicating first communications using a first TRP operation mode, the first TRP operation mode including a sTRP operation mode or a mTRP operation mode. The example method also includes receiving a switching indication indicating a switch from the first TRP operation mode to a second TRP operation mode. The example method also includes communicating second communications based on the second TRP operation mode.

### INTRODUCTION

The present disclosure relates generally to communication systems, and more particularly, to wireless communication employing multiple transmit-receipt point (TRP) operation and single TRP operation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a user equipment (UE) is provided. The method may include receiving a configuration configuring a plurality of transmission code indication (TCI) codepoints, each TCI codepoint corresponding to at least one TCI state. The example method may also include receiving a first indication indicating a first TCI codepoint. Additionally, the method may include communicating first communications using a first transmit-receipt point (TRP) operation mode, the first communications communicating using a first set of TCI states indicated by the first TCI codepoint, the first TRP operation mode based on the first TCI codepoint, the first TRP operation mode including a single TRP (sTRP) operation mode or a multiple TRP (mTRP) operation mode. The example method may also include receiving a switching indication indicating a switch from the first TRP operation mode to a second TRP operation mode that is different from the first TRP operation mode. Additionally, the method may include communicating second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

In another aspect of the disclosure, an apparatus for wireless communication is provided. The apparatus may be a UE that includes a memory and at least one processor coupled to the memory, the memory and the at least one processor configured to receive a configuration configuring a plurality of TCI codepoints, each TCI codepoint corresponding to at least one TCI state. The memory and the at least one processor may also be configured to receive a first indication indicating a first TCI codepoint. Additionally, the memory and the at least one processor may be configured to communicate first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The memory and the at least one processor may also be configured to receive a switching indication indicating a switch from the first TRP operation mode to a second TRP operation mode that is different from the first TRP operation mode. Additionally, the memory and the at least one processor may be configured to communicate second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

In another aspect of the disclosure, an apparatus for wireless communication at a UE is provided. The apparatus may include means for receiving a configuration configuring a plurality of TCI codepoints, each TCI codepoint corresponding to at least one TCI state. The example apparatus may also include means for receiving a first indication indicating a first TCI codepoint. Additionally, the example apparatus may include means for communicating first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The example apparatus may also include means for receiving a switching indication indicating a switch from the first TRP operation mode to a second TRP operation mode that is different from the first TRP operation mode. Additionally, the example apparatus may include means for communicating second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

In another aspect of the disclosure, a non-transitory computer-readable storage medium storing computer executable code for wireless communication at a UE is provided. The code, when executed, may cause a processor to receive a configuration configuring a plurality of TCI codepoints, each TCI codepoint corresponding to at least one TCI state. The example code, when executed, may also cause the processor to receive a first indication indicating a first TCI codepoint. Additionally, the example code, when executed, may cause the processor to communicate first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The example code, when executed, may also cause the processor to receive a switching indication indicating a switch from the first TRP operation mode to a second TRP operation mode that is different from the first TRP operation mode. Additionally, the example code, when executed, may cause the processor to communicate second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

In an aspect of the disclosure, a method of wireless communication at a network node is provided. The method may include configuring a plurality of TCI codepoints for a UE, each TCI codepoint corresponding to at least one TCI state. The example method may also include outputting a first indication indicating a first TCI codepoint. Additionally, the example method may include communicating first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The example method may also include outputting a switching indication indicating a switch from the first TRP operation mode to a second TRP operation mode that is different from the first TRP operation mode. Additionally, the example method may include communicating second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

In another aspect of the disclosure, an apparatus for wireless communication is provided. The apparatus may be a network node that includes a memory and at least one processor coupled to the memory, the memory and the at least one processor configured to configure a plurality of TCI codepoints for a UE, each TCI codepoint corresponding to at least one TCI state. The memory and the at least one processor may also be configured to output a first indication indicating a first TCI codepoint. Additionally, the memory and the at least one processor may be configured to communicate first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The memory and the at least one processor may also be configured to output a switching indication indicating a switch from the first TRP operation mode to a second TRP operation mode that is different from the first TRP operation mode. Additionally, the memory and the at least one processor may be configured to communicate second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

In another aspect of the disclosure, an apparatus for wireless communication at a network node is provided. The apparatus may include means for configuring a plurality of TCI codepoints for a UE, each TCI codepoint corresponding to at least one TCI state. The example apparatus may also include means for outputting a first indication indicating a first TCI codepoint. Additionally, the example apparatus may include means for communicating first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The example apparatus may also include means for outputting a switching indication indicating a switch from the first TRP operation mode to a second TRP operation mode that is different from the first TRP operation mode. Additionally, the example apparatus may include means for communicating second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

In another aspect of the disclosure, a non-transitory computer-readable storage medium storing computer executable code for wireless communication at a network node is provided. The code, when executed, may cause a processor to configure a plurality of TCI codepoints for a UE, each TCI codepoint corresponding to at least one TCI state. The example code, when executed, may also cause the processor to output a first indication indicating a first TCI codepoint. Additionally, the example code, when executed, may cause the processor to communicate first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The example code, when executed, may also cause the processor to output a switching indication indicating a switch from the first TRP operation mode to a second TRP operation mode that is different from the first TRP operation mode. Additionally, the example code, when executed, may cause the processor to communicate second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 is a diagram illustrating an example disaggregated base station architecture, in accordance with the teachings disclosed herein.

FIG. 3A is a diagram illustrating an example of a first frame, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second frame, in accordance with various aspects of the present disclosure.

FIG. 3D is a diagram illustrating an example of uplink (UL) channels within a subframe, in accordance with various aspects of the present disclosure.

FIG. 4 is a diagram illustrating an example of a base station and user equipment (UE) in an access network.

FIG. 5 is a diagram illustrating mTRP operation, in accordance with various aspects of the present disclosure.

FIG. 6 illustrates example transmissions supported by mTRP operation, in accordance with various aspects of the present disclosure.

FIG. 7 illustrates an example communication flow between a first TRP, a second TRP, and a UE, in accordance with various aspects of the present disclosure.

FIG. 8 illustrates an example mapping between TCI codepoints and TCI states, in accordance with various aspects of the present disclosure.

FIG. 9 is a diagram illustrating example sequences when switching from mTRP operation to sTRP operation, in accordance with various aspects of the present disclosure.

FIG. 10 is a diagram illustrating example sequences when switching from sTRP operation to mTRP operation, in accordance with various aspects of the present disclosure.

FIG. 11 is a flowchart of a method of wireless communication at a UE, in accordance with aspects presented herein.

FIG. 12 is a diagram illustrating an example of a hardware implementation for an example apparatus and/or UE, in accordance with aspects presented herein.

FIG. 13 is a flowchart of a method of wireless communication at a network entity, in accordance with aspects presented herein.

FIG. 14 is a diagram illustrating an example of a hardware implementation for an example network entity, in accordance with aspects presented herein.

### DETAILED DESCRIPTION

In some aspects, a UE may support single TRP (sTRP) operation or multiple TRP (mTRP) operation. In sTRP operation, the UE communicates with a single TRP. In mTRP operation, the UE may communicate with multiple TRPs.

In some examples, the communications between a UE and a first TRP and/or a second TRP may be aperiodic communications. In examples in which a control message schedules an aperiodic communication, the control message may indicate the resources (e.g., time resources and/or frequency resources) associated with the aperiodic communication. For example, the control message may include a grant indicating resources allocated to the UE to use for an uplink communication.

In other examples, the communications may be periodic communications or semi-periodic communications. In examples in which a control message schedules a periodic communication or a semi-periodic communication, the control message may allocate resources for the UE to use for subsequent communications without an explicit control message. For example, a control message may configure the UE to transmit a report to the first TRP every N slots. The control message may also indicate which resources that the UE is to use for each transmission of the report.

In aspects in which the UE performs a TRP operation mode switch from mTRP operation to sTRP operation, resources allocated to the UE for periodic communications or semi-periodic communications while the UE is operating in mTRP may be wasted when the UE switches to sTRP operation. For example, the UE may be allocated resources for using two beams, but in sTRP operation, the UE may be configured to use resources for one beam, which may result in unused or wasted resources that were already allocated to the UE.

In other aspects in which the UE performs a TRP operation mode switch from sTRP operation to mTRP operation, resources allocated to the UE for periodic communications or semi-periodic communications while the UE is operating in sTRP may not be sufficient to support mTRP operation. For example, the UE may be allocated resources for using one beam, but in mTRP operation, the UE may be configured to use resources for two beams, which may result in not enough resources being available to the UE to use for communicating with two beams.

The aspects presented herein may enable a UE to apply a default TCI determination rule when a TRP mode is dynamically switched, which may facilitate improving beam management and, thus, improving communication performance. For example, aspects disclosed herein provide techniques for a UE applying a transmission code indication (TCI) rule that enables the UE to determine which TCI state(s) to use after performing a TRP operation mode switch. In some examples, the UE may determine to use the last activated TCI state(s) associated with a TCI codepoint. In some examples, the UE may identify a TCI codepoint associated with a same number of TCI states that the UE was using before performing the TRP operation mode switch. In some examples, the UE may determine to use a TCI state indicated by a control resource set (CORESET).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

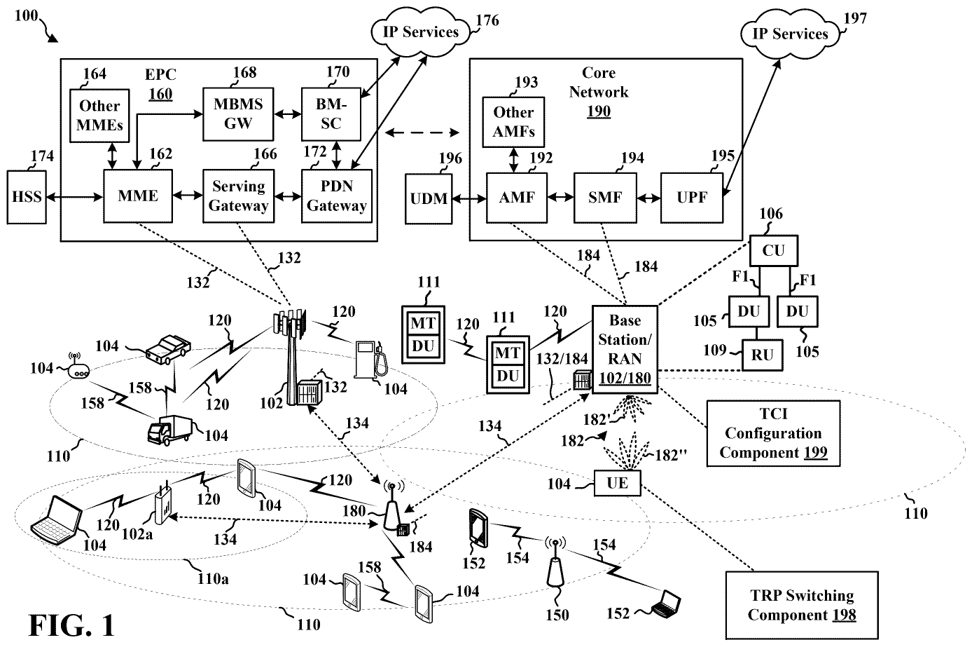

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) (e.g., an EPC 160), and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with the core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or the core network 190) with each other over third backhaul links 134 (e.g., an X2 interface). The first backhaul links 132, the second backhaul links 184 (e.g., an Xn interface), and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g. a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

An access network may include one or more integrated access and backhaul (IAB) nodes (e.g., the IAB nodes 111) that exchange wireless communication with a UE (e.g., one of the UEs 104) or another IAB node to provide access and backhaul to a core network. In an IAB network of multiple IAB nodes, an anchor node may be referred to as an IAB donor. The IAB donor may be a base station (e.g., one of the base stations 102 or one of the base stations 180) that provides access to the core network 190 or the EPC 160 and/or control to one or more of the IAB nodes 111. The IAB donor may include a CU 106 and a DU 105. The IAB nodes 111 may include a DU 105 and a mobile termination (MT). The DU 105 of an IAB node may operate as a parent node, and the MT may operate as a child node.

As described above, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

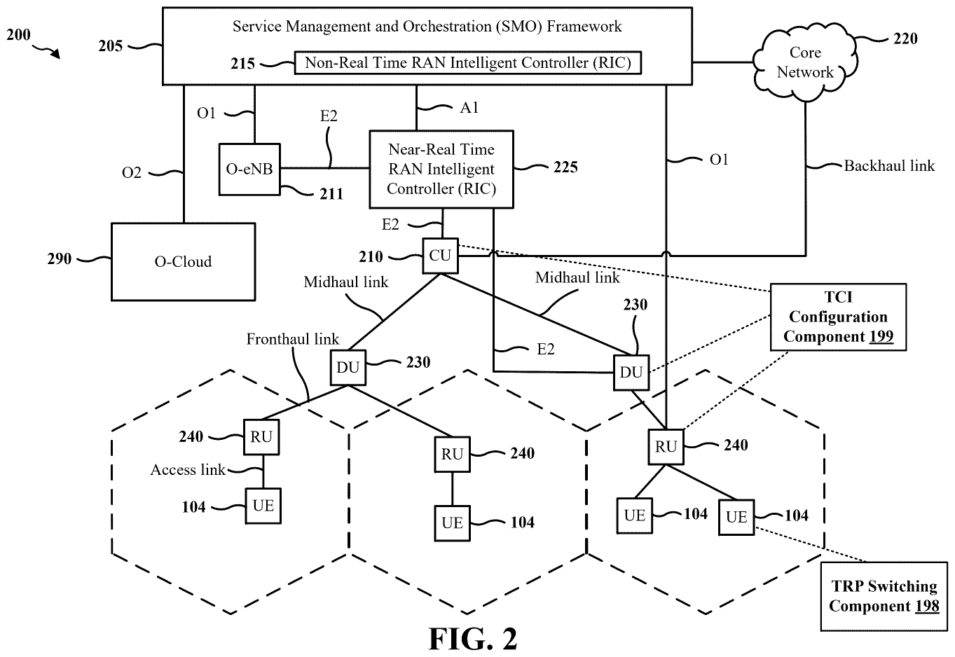

As an example, FIG. 2 shows a diagram illustrating architecture of an example disaggregated base station 200. The disaggregated base station 200 architecture may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g. a Non-RT RIC 215) associated with a Service Management and Orchestration (SMO) Framework (e.g., an SMO Framework 205), or both). The CU 210 (e.g., the CU 106 of FIG. 1) may communicate with one or more DUs (e.g., a DU 230) via respective midhaul links, such as an F1 interface. A DU 230 (e.g., the DU 105 of FIG. 1) may communicate with one or more RUs (e.g., an RU 240) via respective fronthaul links. An RU 240 (e.g., the RU 109 of FIG. 1) may communicate with respective UEs (e.g., the UEs 104 of FIG. 1) via one or more radio frequency (RF) access links. In some implementations, a UE may be simultaneously served by multiple RUs.

Each of the units, i.e., the CU 210, the DU 230, the RU 240, as well as the Near-RT RIC 225, the Non-RT RIC 215, and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) can be implemented to handle over the air (OTA) communication with one or more of the UEs 104. In some implementations, real-time and non-real-time aspects of control and user plane communication with the RU(s) can be controlled by the corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud 290 (O-Cloud)) to perform network element life cycle management (such as to instantiate virtualized network elements) via a cloud computing platform interface (such as an O2 interface). Such virtualized network elements can include, but are not limited to, the CU 210, the DU 230, the RU 240 and the Near-RT RIC 225. In some implementations, the SMO Framework 205 can communicate with a hardware aspect of a 4G RAN, such as an open eNB (O-eNB) (e.g., an O-eNB 211), via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

Referring again to FIG. 1, the base stations 102 may wirelessly communicate with the UEs 104. Each of the base stations 102 may provide communication coverage for a respective geographic coverage area (e.g., a coverage area 110). There may be overlapping geographic coverage areas. For example, a small cell 102a may have a coverage area 110a that overlaps the coverage area 110 of one or more of the base stations 102 (e.g., one or more macro base stations). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5 MHz, 10 MHz, 15 MHz, 20 MHz, 100 MHz, 400 MHz, etc.) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some of the UEs 104 may communicate with each other using device-to-device (D2D) communication link (e.g., a D2D communication link 158). The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) (e.g., STAs 152) via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102a may operate in a licensed and/or an unlicensed frequency spectrum. When operating in an unlicensed frequency spectrum, the small cell 102a may employ NR and use the same unlicensed frequency spectrum (e.g., 5 GHZ, or the like) as used by the Wi-Fi AP 150. The small cell 102a, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell 102a or a large cell (e.g., a macro base station), may include and/or be referred to as an eNB, gNodeB (gNB), or another type of base station. Some base stations, such as a gNB (e.g., one of the base stations 180) may operate in a traditional sub 6 GHz spectrum, in millimeter wave frequencies, and/or near millimeter wave frequencies in communication with the UEs 104. When the gNB operates in millimeter wave or near millimeter wave frequencies, the gNB may be referred to as a millimeter wave base station. The millimeter wave base station may utilize beamforming 182 with one or more of the UEs 104 to compensate for path loss and short range. The base stations 180 and the UEs 104 may each include a plurality of antennas, such as antenna elements, antenna panels, and/or antenna arrays to facilitate the beamforming.

The base stations 180 may transmit a beamformed signal to one or more of the UEs 104 in one or more transmit directions 182′. A UE may receive the beamformed signal from the base station in one or more receive directions 182″. The UE may also transmit a beamformed signal to the base station in one or more transmit directions. The base stations 180 may receive the beamformed signal from the UE in one or more receive directions. The base stations 180/the UEs 104 may perform beam training to determine the best receive and transmit directions for each of the base station/the UE. The transmit and receive directions for the base station may or may not be the same. The transmit and receive directions for the UE may or may not be the same.

The EPC 160 may include a Mobility Management Entity (MME) (e.g., an MME 162), other MMEs 164, a Serving Gateway 166, a Multimedia Broadcast Multicast Service (MBMS) Gateway (e.g., an MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) (e.g., an SMF 194), and a User Plane Function (UPF) (e.g., a UPF 195). The AMF 192 may be in communication with a Unified Data Management (UDM) (e.g., a UDM 196). The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base stations 102 provide an access point to the EPC 160 or the core network 190 for the UEs 104. Examples of the UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UEs 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a network, such as one of the UEs 104 in communication with a network entity, such as one of the base stations 102 or a component of a base station (e.g., a CU 106, a DU 105, and/or an RU 109), may be configured to manage one or more aspects of wireless communication. For example, one of the UEs 104 may include a TRP switching component 198 configured to facilitate applying a default unified TCI rule for periodic or semi-periodic communications after performing a TRP operation mode switch between mTRP operation and sTRP operation.

In certain aspects, the TRP switching component 198 may be configured to receive a configuration configuring a plurality of TCI codepoints, each TCI codepoint corresponding to at least one TCI state. The example TRP switching component 198 may also be configured to receive a first indication indicating a first TCI codepoint. Additionally, the example TRP switching component 198 may be configured to communicate first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The example TRP switching component 198 may also be configured to receive a switching indication indicating a switch from the first TRP operation mode to a second TRP operation mode that is different from the first TRP operation mode. Additionally, the example TRP switching component 198 may be configured to communicate second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

In another configuration, a network entity, such as one of the base stations 102 or a component of a base station (e.g., a CU 106, a DU 105, and/or an RU 109), may be configured to manage or more aspects of wireless communication. For example, one of the base stations 102 may include a TCI configuration component 199 configured to facilitate applying a default unified TCI rule for periodic or semi-periodic communications after performing a TRP operation mode switch between mTRP operation and sTRP operation.

In certain aspects, the TCI configuration component 199 may be configured to configure a plurality of TCI codepoints for a UE, each TCI codepoint corresponding to at least one TCI state. The example TCI configuration component 199 may also be configured to output a first indication indicating a first TCI codepoint. Additionally, the example TCI configuration component 199 may be configured to communicate first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The example TCI configuration component 199 may also be configured to output a switching indication indicating a switch from the first TRP operation mode to a second TRP operation mode that is different from the first TRP operation mode. Additionally, the example TCI configuration component 199 may be configured to communicate second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

The aspects presented herein may enable a UE to apply a default TCI determination rule when a TRP mode is dynamically switched, which may facilitate improving beam management and, thus, improving communication performance.

Although the following description provides examples directed to 5G NR, the concepts described herein may be applicable to other similar areas, such as LTE, LTE-A, CDMA, GSM, 6G, and/or other wireless technologies.

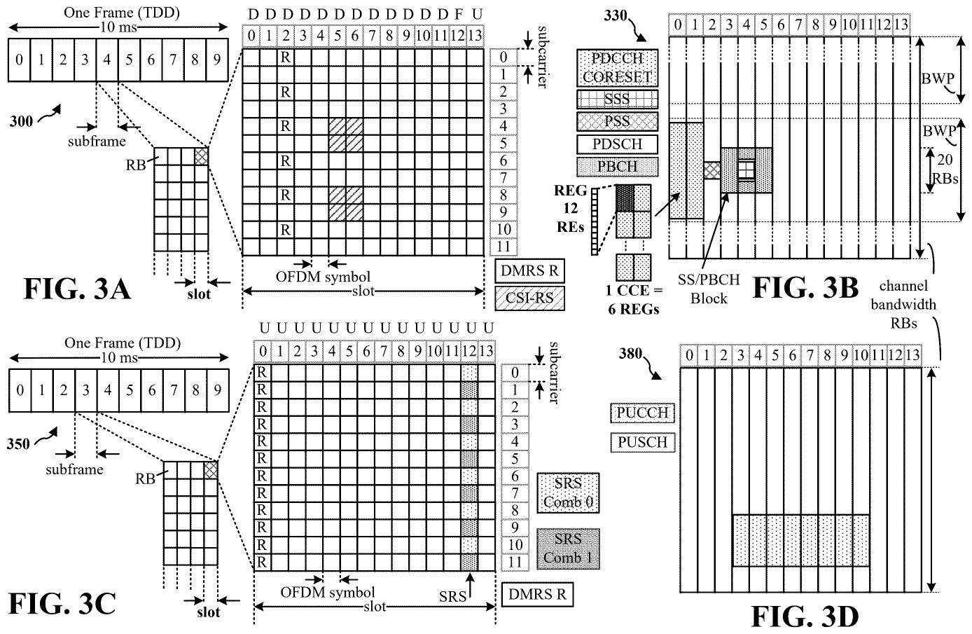

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δƒ = 2^{μ} · 15[kHz] | [symbol] prefix |
|---|---|---|
| 0 | 15 | [symbol] |
| 1 | 30 | [symbol] |
| 2 | 60 | Extended |
| 3 | 120 | [symbol] |
| 4 | 240 | [symbol] |
| 5 | 480 | [symbol] |
| 6 | 960 | [symbol] |

[symbol]

indicates data missing or illegible when filed

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE (e.g., one of the UEs 104 of FIG. 1) to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

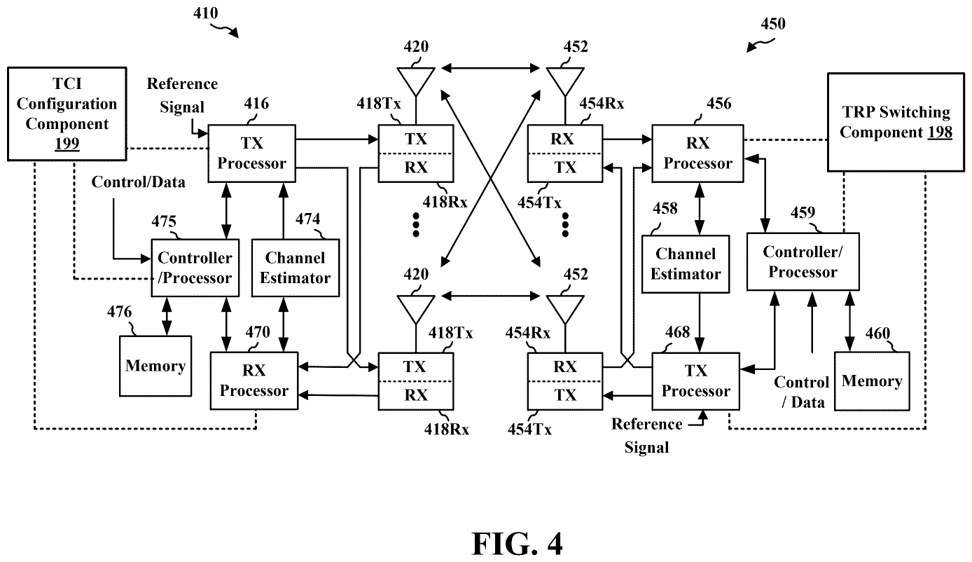

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and memory 476. The example UE 450 includes antennas 452, a transmitter 454Tx, a receiver 454Rx, an RX processor 456, a channel estimator 458, a controller/processor 459, memory 460, and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the memory 460 that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

In some aspects, a UE may support single TRP (sTRP) operation or multiple TRP (mTRP) operation. In sTRP operation, the UE communicates with a single TRP. In mTRP operation, the UE may communicate with multiple TRPs.

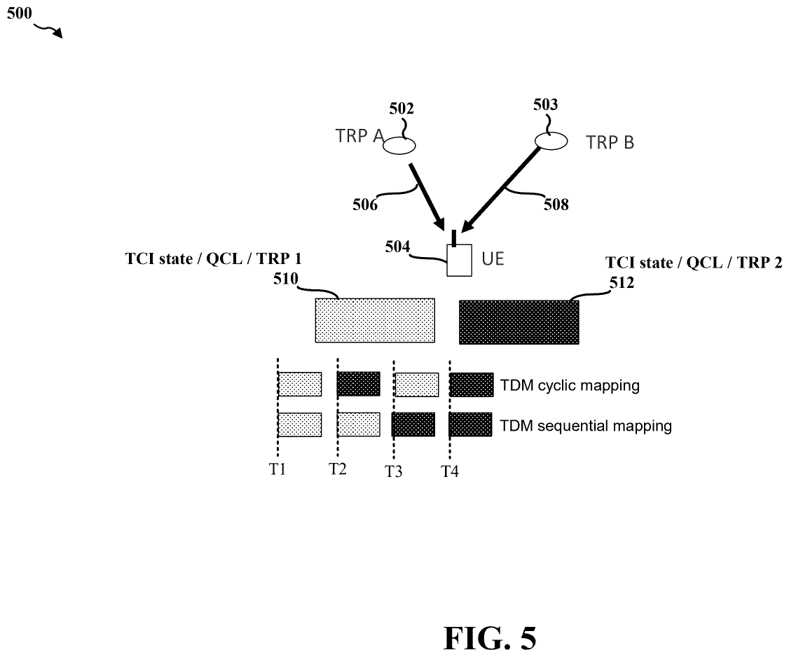

FIG. 5 is a diagram illustrating an example of a wireless communication system 500 employing a UE 504, a first TRP 502 (“TRP A”), and a second TRP 503 (“TRP B”), as presented herein. In the illustrated example of FIG. 5, the first TRP 502 may output (e.g., transmit) a first communication 506 that is received by the UE 504. The second TRP 503 may output a second communication 508 that is received by the UE 504.

In the illustrated example of FIG. 5, the UE 504 may receive the first communication 506 using a first TCI state 510. For example, the UE 504 may use the first TCI state 510 to determine a beam to receive the first communication 506. The first TCI state 510 may be associated with a first TRP (e.g., the first TRP 502). In some examples, the first TCI state 510 may be associated with a first set of quasi co-location (QCL) parameters.

In the illustrated example of FIG. 5, the UE 504 may receive the second communication 508 using a second TCI state 512. For example, the UE 504 may use the second TCI state 512 to determine a beam to receive the second communication 508. The second TCI state 512 may be associated with a second TRP (e.g., the second TRP 503). In some examples, the second TCI state 512 may be associated with a second set of QCL parameters.

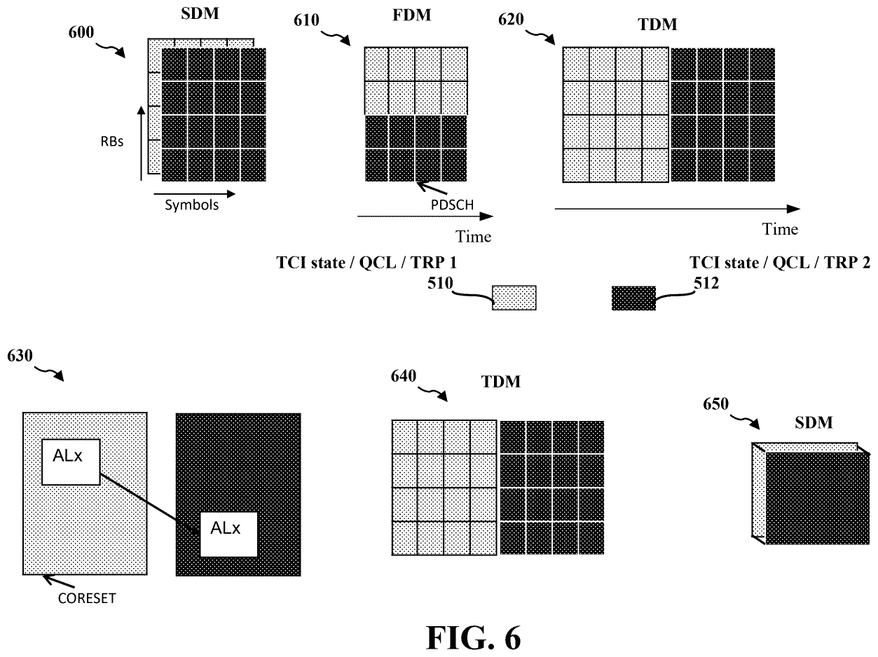

FIG. 6 illustrates example transmissions supported by the mTRP operation of FIG. 5, as presented herein. In the example of FIG. 6, the different transmission types are described in connection with the wireless communication system 500 of FIG. 5. For example, the illustrated example of FIG. 6 includes the first TCI state 510 and the second TCI state 512 of FIG. 5.

In the illustrated example of FIG. 6, a first scenario 600 illustrates an example of spatial division multiplexing (SDM) of the TRPs. For example, the first TRP 502 and the second TRP 503 may transmit using different spatial layers in overlapping resource blocks/symbols and with different TCI states (e.g., the first TCI state 510 and the second TCI state 512).

A second scenario 610 of FIG. 6 illustrates an example of frequency division multiplexing (FDM) of the TRPs. For example, the first TRP 502 and the second TRP 503 may transmit using different resource blocks and with different TCI states (e.g., the first TCI state 510 and the second TCI state 512). As shown in the second scenario 610, the different resource blocks associated with each TCI state may overlap in the time domain.

A third scenario 620 of FIG. 6 illustrates an example of time division multiplexing (TDM) of the TRPs. For example, the first TRP 502 and the second TRP 503 may transmit using different symbols (e.g., in different time resources) and with different TCI states (e.g., the first TCI state 510 and the second TCI state 512). As shown in the third scenario 620, the different resource blocks associated with each TCI state are non-overlapping in the time domain.

In some examples, different repetitions may be transmitted within a slot and/or different repetitions in different slots. A fourth scenario 630 of FIG. 6 illustrates an example of DCI repetition of the TRPs. For example, the first TCI state 510 may be associated with a first CORESET and the second TCI state 512 may be associated with a second CORESET. In the example of the fourth scenario 630, DCI may be transmitted via first resources of the first CORESET associated with first TCI state 510. The DCI may also be repeated via second resources of the second CORESET associated with second TCI state 512.

A fifth scenario 640 of FIG. 6 illustrates an example of uplink communication (e.g., PUCCH/PUSCH) repetition. For example, the UE 504 may repeat the uplink communication via the first TCI state 510 and the second TCI state 512. In the example of the fifth scenario 640, the UE 504 may employ TDM for the uplink communication repetition. For example, the first TCI state 510 and the second TCI state 512 are associated with respective resource blocks that are non-overlapping in the time domain.

A sixth scenario 650 of FIG. 6 illustrates an example of a single frequency network (SFN) downlink communication (e.g., an SFN PDCCH and/or an SFN PDSCH). For example, in some aspects, a UE may be moving at a high rate of speed and communicating with a group of TRPs. In these situations, the group of TRPs may send the same information (e.g., control information and/or data) to the UE. Such a communication may be referred to as an SFN downlink communication. In the example of the sixth scenario 650, the first TRP 502 and the second TRP 503 may employ SDM for the SFN downlink communications.

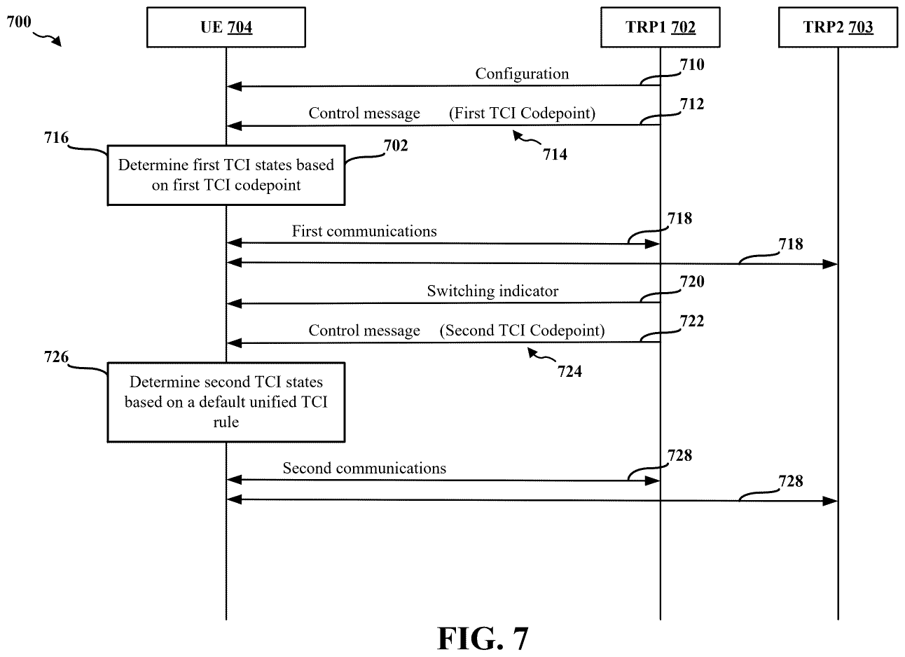

FIG. 7 illustrates an example communication flow 700 between a first TRP 702, a second TRP 703, and a UE 704, as presented herein. One or more aspects described for the first TRP 702 and/or the second TRP 703 may be performed by a component of a base station or a network entity, such as a CU, a DU, and/or an RU. Aspects of the first TRP 702 and the/or the second TRP 703 may be implemented by one of the base stations 102 of FIG. 1 and/or the base station 410 of FIG. 4. Aspects of the UE 704 may be implemented by one of the UEs 104 of FIG. 1 and/or the UE 450 of FIG. 4. Although not shown in the illustrated example of FIG. 4, it may be appreciated that in additional or alternative examples, the first TRP 702, the second TRP 703, and/or the UE 704 may be in communication with one or more other base stations or UEs.

Although the example described in FIG. 7 illustrates the first TRP 702 providing a configuration and control messages to the UE 704, they are merely for illustrative purposes. Aspects presented herein may also be applied to the second TRP 703 providing the configuration and/or the control messages to the UE 704. In addition, the numberings associated with the communication flow do not specify a particular temporal order and are used as numerical references for the communication flow.

In the illustrated example of FIG. 7, the communication flow 700 facilitates the UE 704 applying a TCI determination rule to determine a TCI state to use for communications when a TRP operation mode of the UE 704 is dynamically switched. For example, the UE 704 may be operating in an sTRP operation mode and then receive control messages that may configure the UE 704 to operate in an mTRP operation mode, or vice versa. In some aspects in which the UE 704 communicates after performing the TRP operation mode switch, there may be scenarios in which there is ambiguity as to which TCI state(s) that UE 704 is to use for the communications.

Aspects disclosed herein provide techniques for the UE 704 applying a unified TCI rule that enables the UE 704 to determine which TCI state(s) to use after performing a TRP operation mode switch. In some examples, the UE 704 may determine to use the last activated TCI state(s) associated with a TCI codepoint. In some examples, the UE 704 may identify a TCI codepoint associated with a same number of TCI states that the UE 704 was using before performing the TRP operation mode switch. In some examples, the UE 704 may determine to use a TCI state indicated by a CORESET.

In the illustrated example of FIG. 7, the first TRP 702 may transmit (e.g., output) a configuration 710 that is by the received (e.g., obtained) by the UE 704. The UE 704 may receive the configuration 710 via RRC signaling, a MAC-control element (MAC-CE), and/or DCI. In some examples, the configuration 710 may configure a plurality of CORESETs. Each of the CORESETs may map to one or more TCI states. In some examples, the configuration 710 may configure a plurality of TCI codepoints at the UE 704. Each of the TCI codepoints may map to one or more TCI states.

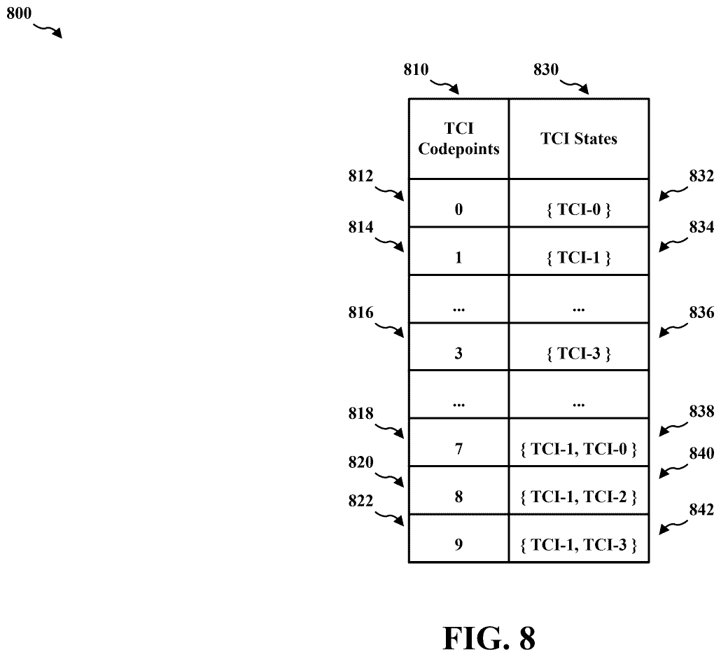

FIG. 8 illustrates an example mapping 800 between TCI codepoints 810 and TCI states 830, as presented herein. For example, each TCI codepoint of the TCI codepoints 810 maps to a set of TCI states. In the example of FIG. 8, each set of TCI states includes one TCI state or two TCI state. However, other examples may include additional or alternative numbers of TCI states in a set of TCI sets.

In the illustrated example of FIG. 8, a first TCI codepoint 812 (“0”) maps to a first TCI set 832 including a single TCI state (“TCI-0”). Similarly, a second TCI codepoint 814 (“1”) maps to a second TCI set 834 including a single TCI state (“TCI-1”). A third TCI codepoint 816 (“3”) maps to a third TCI set 836 including a single TCI state (“TCI-3”).

As shown in FIG. 8, a fourth TCI codepoint 818 (“7”), a fifth TCI codepoint 820 (“8”), and a sixth TCI codepoint 822 (“9”) each map to sets of two respective TCI states. For example, the fourth TCI codepoint 818 maps to a fourth TCI set 838 including two TCI states (“TCI-1” and “TCI-0”). Similarly, the fifth TCI codepoint 820 maps to a fifth TCI set 840 including two TCI states (“TCI-1” and “TCI-2”). The sixth TCI codepoint 822 maps to a sixth TCI set 842 including two TCI states (“TCI-1” and “TCI-3”).

Referring again to the example of FIG. 7, the first TRP 702 transmits a first control message 712 that is received by the UE 704. The first control message 712 may include DCI that is received by the UE 704. The first control message 712 may schedule communications with the UE 704. For example, the first control message 712 may indicate resources for the UE 704 to use for receiving a downlink communication from the first TRP 702 and/or the second TRP 703. In other examples, the first control message 712 may indicate resources for the UE 704 to use to transmit an uplink communication to the first TRP 702 and/or the second TRP 703.

As shown in FIG. 7, the first control message 712 may include a first TCI codepoint 714. The first TCI codepoint 714 may include a TCI codepoint that is configured at the UE 704 via the configuration 710. The UE 704 may then perform a TCI states determination procedure 716 to determine first TCI states to use for communicating (e.g., for communications based on the first control message 712). For example, the TCI states determination procedure 716 may use the configuration 710 to map the first TCI codepoint 714 to a set of TCI states. For example, and referring to the example mapping 800 of FIG. 8, the UE 704 may map the first TCI codepoint 812 to the first TCI set 832, may map the second TCI codepoint 814 to the second TCI set 834, may map the third TCI codepoint 816 to the third TCI set 836, etc.

Referring again to the example of FIG. 7, the UE 704 may communicate first communications 718 with the first TRP 702 and/or the second TRP 703. The UE 704 may communicate the first communications 718 using beam(s) based on the determined TCI states.

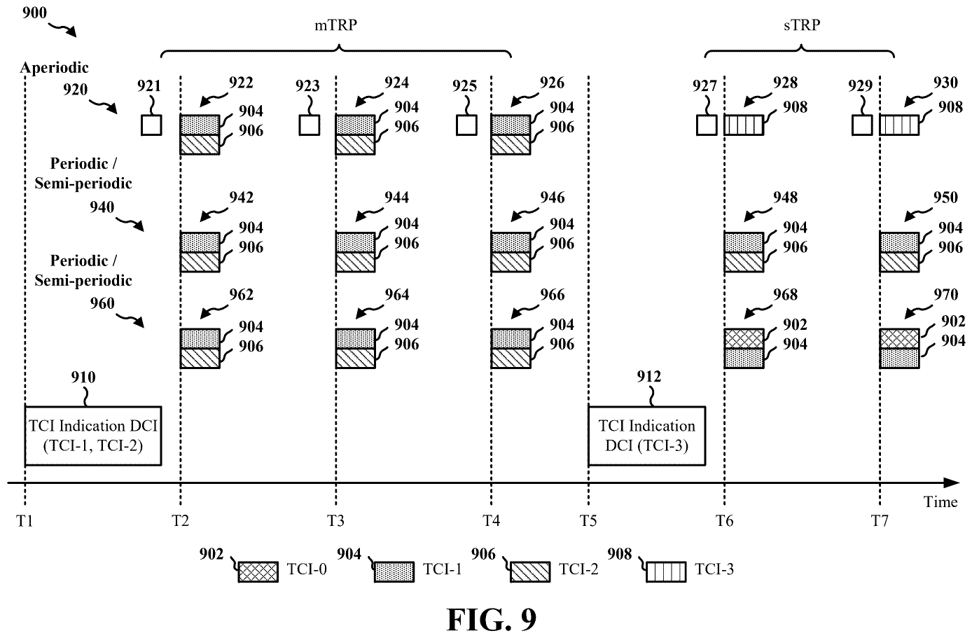

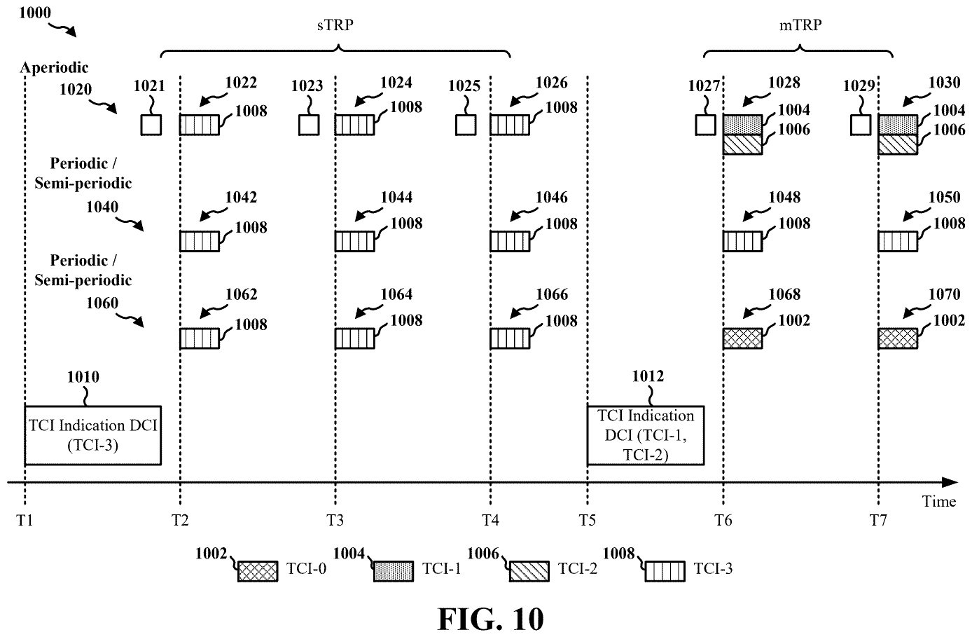

As shown in FIG. 7, the first TRP 702 may transmit a switching indicator 720 that is received by the UE 704. The switching indicator 720 may configure the UE 704 to perform a switch from the mTRP operation mode to the sTRP operation mode, as described in connection with FIG. 9. In some examples, the switching indicator 720 may configure the UE 704 to perform a switch from the sTRP operation mode to the mTRP operation mode, as described in connection with FIG. 10. The switching indicator 720 may include RRC configuration signaling, a MAC-CE indication, and/or a DCI indication. In some examples, the switching indicator 720 may be an implicit signaling such as a TCI indication DCI indicating a different number of TCI states, where a single TCI in a TCI codepoint is indicated for sTRP operation, and multiple TCIs in a TCI codepoint is indicated for mTRP operation.

In the illustrated example of FIG. 7, the first TRP 702 may transmit a second control message 722 that is received by the UE 704. The second control message 722 may include DCI that is received by the UE 704. The second control message 722 may schedule communications with the UE 704, such as second communications 728. For example, the second control message 722 may indicate resources for the UE 704 to use for receiving a downlink communication from the first TRP 702 and/or the second TRP 703. In other examples, the second control message 722 may indicate resources for the UE 704 to use to transmit an uplink communication to the first TRP 702 and/or the second TRP 703.

As shown in FIG. 7, the second control message 722 may include a second TCI codepoint 724. Similar to the first TCI codepoint 714, the second TCI codepoint 724 may include a TCI codepoint that is configured at the UE 704 via the configuration 710.

The UE 704 may then perform a TCI states determination procedure 726 to determine second TCI states based on a default unified TCI rule, for example, after performing the TRP operation mode switch. The UE 704 may use the second TCI states for communicating the second communications 728 with the first TRP 702 and/or the second TRP 703.

Although the example of FIG. 7 illustrates the switching indicator 720 and the second control message 722 as separate signaling, in other examples, switching indicator 720 and the second control message 722 may be included in same signaling. In some aspects, the second TCI codepoint 724 may indicate that the UE 704 is to perform a TRP operation mode switch. For example, the first TCI codepoint 714 may map to a single TCI state (e.g., the first TCI set 832, the second TCI set 834, the third TCI set 836, etc.) and configure the UE 704 to operate in an sTRP operation mode, and the second TCI codepoint 724 may map to two TCI states (e.g., the fourth TCI set 838, the fifth TCI set 840, the sixth TCI set 842, etc.) and configure the UE 704 to operation in an mTRP operation mode. In other examples, the first TCI codepoint 714 may map to two TCI states (e.g., the fourth TCI set 838, the fifth TCI set 840, the sixth TCI set 842, etc.) and configure the UE 704 to operate in an mTRP operation mode, and the second TCI codepoint 724 may map to a single TCI state (e.g., the first TCI set 832, the second TCI set 834, the third TCI set 836, etc.) and configure the UE 704 to operation in an sTRP operation mode

In some examples, the communications between the UE 704 and the first TRP 702 and/or the second TRP 703 may be aperiodic communications. For example, the first control message 712 may schedule the first communications 718 and/or the second control message 722 may schedule the second communications 728. In examples in which a control message schedules an aperiodic communication, the control message may indicate the resources (e.g., time resources and/or frequency resources) associated with the aperiodic communication. For example, the control message may include a grant indicating resources allocated to the UE 704 to use for an uplink communication.

In other examples, the communications may be periodic communications or semi-periodic communications. In examples in which a control message schedules a periodic communication or a semi-periodic communication, the control message may allocate resources for the UE 704 to use for subsequent communications without an explicit control message. For example, a control message may configure the UE 704 to transmit a report to the first TRP 702 every N slots. The control message may also indicate which resources that the UE 704 is to use for each transmission of the report.

In aspects in which the UE 704 performs a TRP operation mode switch, resources allocated to the UE 704 for periodic communications or semi-periodic communications while the UE 704 is operating in mTRP may be wasted when the UE 704 switches to sTRP operation. For example, the UE 704 may be allocated resources for using two beams, but in sTRP operation, the UE 704 may be configured to use resources for one beam, which may result in unused or wasted resources that were already allocated to the UE 704.

In other aspects in which the UE 704 performs a TRP operation mode switch from sTRP operation to mTRP operation, resources allocated to the UE 704 for periodic communications or semi-periodic communications while the UE 704 is operating in sTRP may not be sufficient to support mTRP operation. For example, the UE 704 may be allocated resources for using one beam, but in mTRP operation, the UE 704 may be configured to use resources for two beams, which may result in not enough resources being available to the UE 704 to use for communicating with two beams.

In some examples, a periodic or semi-periodic communications may include a single frequency network (SFN) transmission in which multiple TRPs transmit the same data to the UE. In some such examples, the periodic or semi-periodic communications may be based on an SFN CORESET configured to use two TCI states that map to two TRPs, such as the first TRP 702 and the second TRP 703.

In some examples, the periodic or semi-periodic communications may include semi-persistent scheduling (SPS) activated via SFN PDSCH configured to use two TCI states that map to two TRPs, such as the first TRP 702 and the second TRP 703.

In some examples, the periodic or semi-periodic communications may include SPS activated with two TCIs for SDM, FDM, or TDM based on a single DCI for mTRP operation. For example, a downlink communication, such as PDSCH, may be transmitted by multiple TRPs and scheduled by a single DCI.

In some examples, the periodic or semi-periodic communications may include a PUCCH resource configured to use two TCI states mapped to two TRPs, such as the first TRP 702 and the second TRP 703.

In some examples, the periodic or semi-periodic communications may include a Type-1 or Type-2 configured grant that is configured or activated with two SRS resource indicators (SRIs). The two SRIs may correspond to two SRS resource sets mapped to two TCI states. In some examples, the periodic or semi-periodic communications may include PUSCH with TDM repetition. In some examples, the periodic or semi-periodic communications may include SDM transmissions.

FIG. 9 is a diagram 900 illustrating example sequences when switching from mTRP operation to sTRP operation, as presented herein. In the example of FIG. 9, a UE may be configured to communicate using beams based on TCI states. The TCI states may be indicated via a TCI codepoint, such as the example TCI codepoints 810 of FIG. 8.

In the illustrated example of FIG. 9, the UE receives a first TCI indication 910 at a time T1. The UE may receive the first TCI indication 910 via DCI. In the example of FIG. 9, the first TCI indication 910 maps to two TCI states (“TCI-1” and “TCI-2”). Thus, the UE may be configured to operate in mTRP after receiving the first TCI indication 910.

As shown in FIG. 9, the UE may receive a second TCI indication 912 at a time T5. The UE may receive the second TCI indication 912 via DCI. In the example of FIG. 9, the second TCI indication 912 maps to a single TCI state (“TCI-3”). Thus, the UE may be configured to operate in sTRP after receiving the second TCI indication 912.

In some examples, the second TCI indication 912 may facilitate configuring the UE to perform a TRP operation mode switch from mTRP to sTRP. In other examples, the UE may receive control signaling, such as the switching indicator 720 of FIG. 7, to cause the UE to perform the TRP operation mode switch from mTRP to sTRP.

In the illustrated example of FIG. 9, the diagram 900 includes a first sequence 920 associated with aperiodic communications. For example, at a time T2, the UE may communicate a first communication 922 using beams based on the two TCI states indicated by the first TCI indication 910 (e.g., a TCI-1 state 904 and a TCI-2 state 906). For example, the UE may use a first beam based on the TCI-1 state 904 and use a second beam based on the TCI-2 state 906. In a similar manner, the UE may communicate a second communication 924 at a time T3 and a third communication 926 at a time T4. The UE may use the same beams for communicating the second communication 924 and the third communication 926 as the UE used for communicating the first communication 922. For example, the UE may use the first beam based on the TCI-1 state 904 and use a second beam based on the TCI-2 state 906.

In the example of FIG. 9, after performing the switch from mTRP operation to sTRP operation (e.g., after receiving the second TCI indication 912), the UE may transmit a fourth communication 928 at a time T6 and a fifth communication 930 at a time T7. In the example first sequence 920 of FIG. 9, the UE may use a third beam based on a TCI state indicated by the second TCI indication 912 (e.g. a TCI-3 state 908) to communicate the fourth communication 928 and the fifth communication 930.

In the example first sequence 920 of FIG. 9, the first sequence 920 includes aperiodic communications that may be scheduled by different dynamic grants. For example, a first dynamic grant 921 may schedule the first communication 922, a second dynamic grant 923 may schedule the second communication 924, a third dynamic grant 925 may schedule the third communication 926, a fourth dynamic grant 927 may schedule the fourth communication 928, and a fifth dynamic grant 929 may schedule the fifth communication 930. Thus, the UE may be provided or allocated the resources by the fourth dynamic grant 927 and the fifth dynamic grant 929 to communicate the fourth communication 928 and the fifth communication 930, respectively, and, thus, there are no unused resources associated with switching mTRP operation to sTRP operation.

In the illustrated example of FIG. 9, the diagram 900 includes a second sequence 940 and a third sequence 960 that are each associated with periodic communications or semi-periodic communications. Referring to the second sequence 940, at a time T2, the UE may communicate a first communication 942 using beams based on the two TCI states indicated by the first TCI indication 910 (e.g., the TCI-1 state 904 and the TCI-2 state 906). For example, the UE may use a first beam based on the TCI-1 state 904 and use a second beam based on the TCI-2 state 906. In a similar manner, the UE may communicate a second communication 944 at a time T3 and a third communication 946 at a time T4. The UE may use the same beams for communicating the second communication 944 and the third communication 946 as the UE used for communicating the first communication 942. In the example of FIG. 9, after performing the switch from mTRP operation to sTRP operation (e.g., after receiving the second TCI indication 912), the UE may transmit a fourth communication 948 at a time T6 and a fifth communication 950 at a time T7.

Referring to the third sequence 960, the UE may transmit a first communication 962 at a time T2, a second communication 964 at a time T3, and a third communication 966 at a time T4. The UE may use the same beams to transmit the first communication 962, the second communication 964, and the third communication 966. For example, the UE may use beams based on the TCI-1 state 904 and the TCI-2 state 906, as indicated by the first TCI indication 910. In the example of FIG. 9, after performing the switch from mTRP operation to sTRP operation (e.g., after receiving the second TCI indication 912), the UE may transmit a fourth communication 968 at a time T6 and a fifth communication 970 at a time T7.

As shown in FIG. 9, when switching from mTRP to sTRP for periodic communications or semi-periodic communications, the UE may continue to use two TCI states to facilitate the fourth communication and the fifth communication. The UE may continue to use two TCI states as the UE was allocated resources to use for two TCI states when operating in mTRP. In such scenarios, switching to a single TCI state for transmitting the fourth communication and the fifth communication may result in unused resources that were already allocated to the UE.

In the example second sequence 940 of FIG. 9, the UE may apply a first default unified TCI rule to determine which beams to use for transmitting the fourth communication 948 and the fifth communication 950. For example, the first default unified TCI rule may include using the latest activated two TCI states in a TCI codepoint. That is, the UE may continue using the last two activated TCI states that are included in a TCI codepoint. In the illustrated example of FIG. 9, the UE may continue to use the TCI-1 state 904 and the TCI-2 state 906 to communicate the fourth communication 948 and the fifth communication 950.

In the example third sequence 960 of FIG. 9, the UE may apply a second default unified TCI rule to determine which beams to use for transmitting the fourth communication 968 and the fifth communication 970. For example, the second default unified TCI rule may include using two TCI states mapped to a TCI codepoint with the lowest identifier (ID) among all TCI codepoints including two TCI states. That is, the UE may identify which TCI codepoints of a plurality of TCI codepoints map to two TCI states. The UE may then select the two TCI states that correspond to the TCI codepoint with the lowest ID.

For example, and referring to the example mapping 800 of FIG. 8, the UE may identify the TCI codepoint with the lowest ID that maps to two TCI states. In the example of FIG. 8, the UE may determine that the fourth TCI codepoint 818 is the TCI codepoint with the lowest ID (“7”) that maps to two TCI states (e.g., the fourth TCI set 838 including the TCI-0 state and the TCI-1 state). As shown in FIG. 9, the UE may use two beams based on a TCI-0 state 902 and the TCI-1 state 904 for communicating the fourth communication 968 and the fifth communication 970.

In the example second sequence 940 and the third sequence 960, the UE continues to use two beams based on two TCI states when communicating the periodic or semi-periodic communications associated with the fourth communication and the fifth communication. It may be appreciated that by continuing to use two beams based on two TCI states, the UE may continue to use the resources that were allocated for the periodic or semi-periodic communications while the UE was operating in mTRP.

FIG. 10 is a diagram 1000 illustrating example sequences when switching from sTRP operation to mTRP operation, as presented herein. In the example of FIG. 10, a UE may be configured to communicate using beams based on TCI states. The TCI states may be indicated via a TCI codepoint, such as the example TCI codepoints 810 of FIG. 8.

In the illustrated example of FIG. 10, the UE receives a first TCI indication 1010 at a time T1. The UE may receive the first TCI indication 1010 via DCI. In the example of FIG. 10, the first TCI indication 1010 maps to a single TCI state (“TCI-3”). Thus, the UE may be configured to operate in mTRP after receiving the first TCI indication 1010.

As shown in FIG. 10, the UE may receive a second TCI indication 1012 at a time T5. The UE may receive the second TCI indication 1012 via DCI. In the example of FIG. 10, the second TCI indication 1012 maps to two TCI states (“TCI-1” and “TCI-2”). Thus, the UE may be configured to operate in mTRP after receiving the second TCI indication 1012.

In some examples, the second TCI indication 1012 may facilitate configuring the UE to perform a TRP operation mode switch from sTRP to mTRP. In other examples, the UE may receive control signaling, such as the switching indicator 720 of FIG. 7, to cause the UE to perform the TRP operation mode switch from sTRP to mTRP.

In the illustrated example of FIG. 10, the diagram 1000 includes a first sequence 1020 associated with aperiodic communications. For example, the UE may communicate a first communication 1022 at a time T2, may communicate a second communication 1024 at a time T3, and may communicate a third communication 1026 at a time T4. The UE may use the same beam to communicate the first communication 1022, the second communication 1024, and the third communication 1026. For example, the UE may use a beam based on the single TCI state indicated by the first TCI indication 1010 (e.g., a TCI-3 state 1008).

In the example of FIG. 10, after performing the switch from sTRP operation to mTRP operation (e.g., after receiving the second TCI indication 1012), the UE may transmit a fourth communication 1028 at a time T6 and a fifth communication 1030 at a time T7. In the example first sequence 1020 of FIG. 10, the UE may use beams based on the TCI states indicated by the second TCI indication 1012 (e.g., a TCI-1 state 1004 and a TCI-2 state 1006). For example, the UE may use a first beam based on the TCI-1 state 1004 and may use a second beam based on the TCI-2 state 1006.

In the example first sequence 1020 of FIG. 10, the first sequence 1020 includes aperiodic communications that may be scheduled by different dynamic grants. For example, a first dynamic grant 1021 may schedule the first communication 1022, a second dynamic grant 1023 may schedule the second communication 1024, a third dynamic grant 1025 may schedule the third communication 1026, a fourth dynamic grant 1027 may schedule the fourth communication 1028, and a fifth dynamic grant 1029 may schedule the fifth communication 1030. Thus, the UE may be provided or allocated the resources by the fourth dynamic grant 1027 and the fifth dynamic grant 1029 to communicate the fourth communication 1028 and the fifth communication 1030, respectively, and, thus, there are no unused resources associated with switching sTRP operation to mTRP operation.

In the illustrated example of FIG. 10, the diagram 1000 includes a second sequence 1040 and a third sequence 1060 that are each associated with periodic communications or semi-periodic communications. Referring to the second sequence 1040, at a time T2, the UE may communicate a first communication 1042 using a beam based on the single TCI state indicated by the first TCI indication 1010 (e.g., the TCI-3 state 1008). For example, the UE may use a first beam based on the TCI-3 state 1008. In a similar manner, the UE may communicate a second communication 1044 at a time T3 and a third communication 1046 at a time T4. The UE may use the same beam for communicating the second communication 1044 and the third communication 1046 as the UE used for communicating the first communication 1042. In the example of FIG. 10, after performing the switch from sTRP operation to mTRP operation (e.g., after receiving the second TCI indication 1012), the UE may transmit a fourth communication 1048 at a time T6 and a fifth communication 1050 at a time T7.

Referring to the third sequence 1060, the UE may transmit a first communication 1062 at a time T2, a second communication 1064 at a time T3, and a third communication 1066 at a time T4. The UE may use the same beam to transmit the first communication 1062, the second communication 1064, and the third communication 1066. For example, the UE may use a first beam based on the TCI-3 state 1008, as indicated by the first TCI indication 1010. In the example of FIG. 10, after performing the switch from sTRP operation to mTRP operation (e.g., after receiving the second TCI indication 1012), the UE may transmit a fourth communication 1068 at a time T6 and a fifth communication 1070 at a time T7.

As shown in FIG. 10, when switching from sTRP to mTRP for periodic communications or semi-periodic communications, the UE may continue to use a single TCI to facilitate the fourth communication and the fifth communication. The UE may continue to use the single TCI state as the UE was allocated resources to use for one TCI state when operating in sTRP. In such scenarios, the UE may not have resources available for transmitting the fourth communication and the fifth communication using multiple TCI states.

In the example second sequence 1040 of FIG. 10, the UE may apply a first default unified TCI rule to determine which beam to use for transmitting the fourth communication 1048 and the fifth communication 1050. For example, the first default unified TCI rule may include using the latest activated one TCI state in a TCI codepoint. That is, the UE may continue using the last single activated TCI state that was included in a TCI codepoint. In the illustrated example of FIG. 10, the UE may continue to use the TCI-3 state 1008 to communicate the fourth communication 1048 and the fifth communication 1050.

In the example third sequence 1060 of FIG. 10, the UE may apply a second default unified TCI rule to determine which beams to use for transmitting the fourth communication 1068 and the fifth communication 1070. For example, the second default unified TCI rule may include using the one TCI state mapped to the mapped to a TCI codepoint with the lowest ID among all TCI codepoints including a single TCI state. That is, the UE may identify which TCI codepoints of a plurality of TCI codepoints map to one TCI state. The UE may then select the single TCI state that corresponds to the TCI codepoint with the lowest ID.

For example, and referring to the example mapping 800 of FIG. 8, the UE may identify the TCI codepoint with the lowest ID that maps to a single TCI state. In the example of FIG. 8, the UE may determine that the first TCI codepoint 812 is the TCI codepoint with the lowest ID (“0”) that maps to a single TCI state (e.g., the first TCI set 832 including the TCI-0 state). As shown in FIG. 10, the UE may use a single beam based on a TCI-0 state 1002 for communicating the fourth communication 1068 and the fifth communication 1070.

In some examples, the UE may apply a third default unified TCI rule to determine which beam to use for transmitting the fourth communication 1068 and the fifth communication 1070. For example, the third default unified TCI rule may include using the CORESET of the lowest ID with a single activated unified TCI. For example, the UE may be configured with a plurality of CORESETs that each map to one or more TCI states. In such examples, the UE may be configured to identify the CORESET with the lowest ID that maps to a single TCI state.

In the example second sequence 1040 and the third sequence 1060, the UE continues to use a single beam based on a single TCI state when communicating the periodic or semi-periodic communications associated with the fourth communication and the fifth communication. It may be appreciated that by continuing to use a single beam based on a single TCI state, the UE may continue to use the resources that were allocated for the periodic or semi-periodic communications while the UE was operating in STRP.

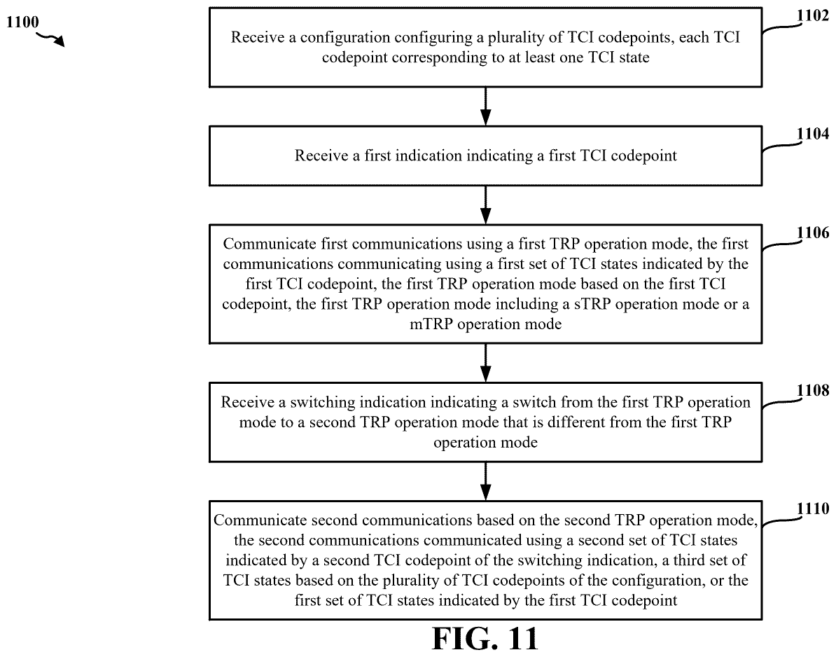

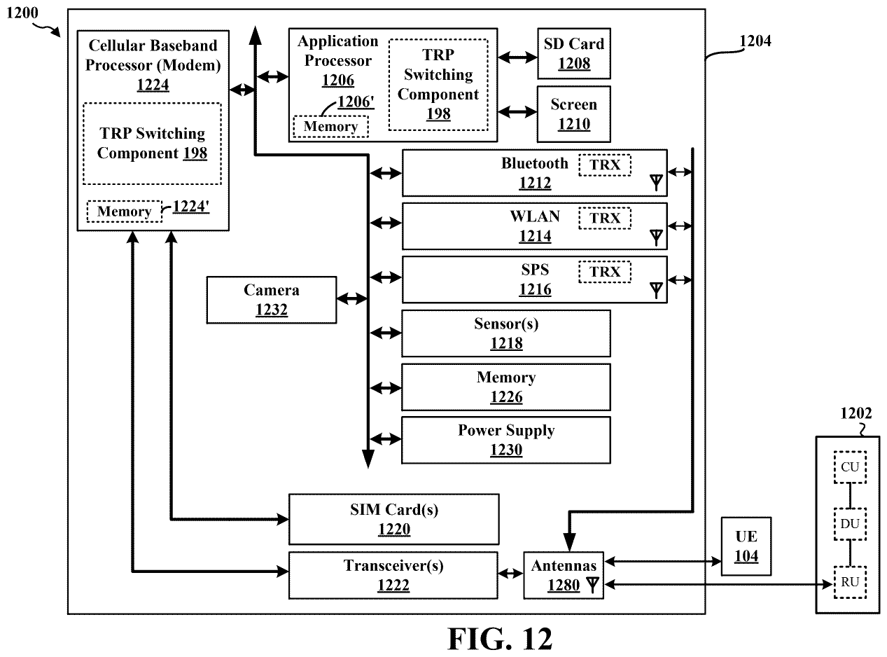

FIG. 11 is a flowchart 1100 of a method of wireless communication. The method may be performed by a UE (e.g., one of the UEs 104, and/or an apparatus 1204 of FIG. 12). The method may facilitate applying a default unified TCI rule for periodic or semi-periodic communications after performing a TRP operation mode switch between mTRP operation and sTRP operation.

At 1102, the UE receives a configuration configuring a plurality of TCI codepoints, each TCI codepoint corresponding to at least one TCI state, as described in connection with configuration 710 of FIG. 7. For example, 1102 may be performed by a cellular RF transceiver 1222/the TRP switching component 198 of the apparatus 1204 of FIG. 12.

At 1104, the UE receives a first indication indicating a first TCI codepoint, as described in connection with the first TCI codepoint 714 and the first control message 712 of FIG. 7. For example, 1104 may be performed by the cellular RF transceiver 1222/the TRP switching component 198 of the apparatus 1204 of FIG. 12.

At 1106, the UE communicates first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode, as described in connection with at least the first communications 718 of FIG. 7. For example, 1106 may be performed by the cellular RF transceiver 1222/the TRP switching component 198 of the apparatus 1204 of FIG. 12.

At 1108, the UE receives a switching indication indicating a switch from the first TRP operation mode to a second TRP operation mode that is different from the first TRP operation mode, as described in connection with at least the switching indicator 720 of FIG. 7. For example, 1108 may be performed by the cellular RF transceiver 1222/the TRP switching component 198 of the apparatus 1204 of FIG. 12.

At 1110, the UE communicates second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint, as described in connection with the second communications 728 of FIG. 7. For example, 1110 may be performed by the cellular RF transceiver 1222/the TRP switching component 198 of the apparatus 1204 of FIG. 12.

In some examples, the first TRP operation mode may include the mTRP operation mode, the second TRP operation mode may include the sTRP operation mode, and the first set of TCI states may include two TCI states, as described in connection with the example sequences of FIG. 9.

In some examples, the second communications may be associated with aperiodic occasions, the second TCI codepoint may correspond to a single TCI state, and the second communications may be communicated using the single TCI state of the second set of TCI states, as described in connection with the first sequence 920 of FIG. 9.

In some examples, the second communications may be associated with periodic occasions or semi-periodic occasions, as described in connection with the second sequence 940 and the third sequence 960 of FIG. 9. In some such examples, the UE may identify a target TCI codepoint of the plurality of TCI codepoints that maps to two TCI states, as described in connection with the second default unified TCI rule of the third sequence 960. The second communications may be communicated using the two TCI states corresponding to the target TCI codepoint.

In some examples, the second communications may be associated with periodic occasions or semi-periodic occasions, and the second communications may be communicated using the two TCI states of the first set of TCI states, as described in connection with the first default unified TCI rule of the second sequence 940 of FIG. 9.

In some examples, the first TRP operation mode includes the sTRP operation mode, the second TRP operation mode includes the mTRP operation mode, and the first set of TCI states includes a single TCI state, as described in connection with the example sequences of FIG. 10.

In some examples, the second communications may be associated with aperiodic occasions, the second TCI codepoint may correspond to two TCI states, and the second communications may be communicated using the two TCI states of the second set of TCI states, as described in connection with the first sequence 1020 of FIG. 10.

In some examples, the second communications may be associated with periodic occasions or semi-periodic occasions, as described in connection with the second sequence 1040 and the third sequence 1060. In some such examples, the UE may identify a target TCI codepoint of the plurality of TCI codepoints that maps to a single TCI state, as described in connection with the second default unified TCI rule of the third sequence 1060 of FIG. 10. The second communications may be communicated using the single TCI state corresponding to the target TCI codepoint.

In some examples, the second communications may be associated with periodic occasions or semi-periodic occasions, and the second communications may be communicated using the single TCI state of the first set of TCI states, as described in connection with the first default unified TCI rule and the second sequence 1040 of FIG. 10.

In some examples, the UE may receive a CORESET configuration including a plurality of CORESETs that are mapping to respective sets of TCI states, as described in connection with the configuration 710 of FIG. 7. The UE may also identify a target CORESET of the plurality of CORESETs that maps to a single activated TCI state, and communicate third communications using the single activated TCI state corresponding to the target CORESET, as described in connection with the third default unified TCI rule and the third sequence 1060 of FIG. 10.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers (e.g., a cellular RF transceiver 1222). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize one or more antennas 1280 for communication. The cellular baseband processor 1224 communicates through transceiver(s) (e.g., the cellular RF transceiver 1222) via one or more antennas 1280 with one of the UEs 104 and/or with an RU associated with a network entity 1202. The cellular baseband processor 1224 and the application processor 1206 may each include a computer-readable medium/memory, such as the on-chip memory 1224′, and the on-chip memory 1206′, respectively. The additional memory modules 1226 may also be considered a computer-readable medium/memory. Each computer-readable medium/memory (e.g., the on-chip memory 1224′, the on-chip memory 1206′, and/or the additional memory modules 1226) may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 450 and may include the memory 460 and/or at least one of the TX processor 468, the RX processor 456, and the controller/processor 459. In one configuration, the apparatus 1204 may be a processor chip (modem and/or application) and include just the cellular baseband processor 1224 and/or the application processor 1206, and in another configuration, the apparatus 1204 may be the entire UE (e.g., see the UE 450 of FIG. 4) and include the additional modules of the apparatus 1204.

As discussed supra, the TRP switching component 198 is configured to receive a configuration configuring a plurality of TCI codepoints, each TCI codepoint corresponding to at least one TCI state. The TRP switching component 198 is also configured to receive a first indication indicating a first TCI codepoint. Additionally, the TRP switching component 198 is configured to communicate first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The TRP switching component 198 is also configured to receive a switching indication indicating a switch from the first TRP operation mode to a second TRP operation mode that is different from the first TRP operation mode. Additionally, the TRP switching component 198 is configured to communicate second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

The TRP switching component 198 may be within the cellular baseband processor 1224, the application processor 1206, or both the cellular baseband processor 1224 and the application processor 1206. The TRP switching component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1204 may include a variety of components configured for various functions. For example, the TRP switching component 198 may include one or more hardware components that perform each of the blocks of the algorithm in the flowcharts of FIG. 11.

In one configuration, the apparatus 1204, and in particular the cellular baseband processor 1224 and/or the application processor 1206, includes means for receiving a configuration configuring a plurality of transmission code indication (TCI) codepoints, each TCI codepoint corresponding to at least one TCI state. The example apparatus 1204 also includes means for receiving a first indication indicating a first TCI codepoint. The example apparatus 1204 also includes means for communicating first communications using a first transmit-receipt point (TRP) operation mode, the first communications communicating using a first set of TCI states indicated by the first TCI codepoint, the first TRP operation mode based on the first TCI codepoint, the first TRP operation mode including a single TRP (sTRP) operation mode or a multiple TRP (mTRP) operation mode. The example apparatus 1204 also includes means for receiving a switching indication indicating a switch from the first TRP operation mode to a second TRP operation mode that is different from the first TRP operation mode. The example apparatus 1204 also includes means for communicating second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

In another configuration, the example apparatus 1204 also includes means for identifying a target TCI codepoint of the plurality of TCI codepoints that maps to two TCI states, and where the second communications are communicated using the two TCI states corresponding to the target TCI codepoint.

In another configuration, the example apparatus 1204 also includes means for identifying a target TCI codepoint of the plurality of TCI codepoints that maps to a single TCI state, and where the second communications are communicated using the single TCI state corresponding to the target TCI codepoint.

In another configuration, the example apparatus 1204 also includes means for receiving a control resource set (CORESET) configuration including a plurality of CORESETs that are mapping to respective sets of TCI states. The example apparatus 1204 also includes means for identifying a target CORESET of the plurality of CORESETs that maps to a single activated TCI state. The example apparatus 1204 also includes means for communicating third communications using the single activated TCI state corresponding to the target CORESET.

The means may be the TRP switching component 198 of the apparatus 1204 configured to perform the functions recited by the means. As described supra, the apparatus 1204 may include the TX processor 468, the RX processor 456, and the controller/processor 459. As such, in one configuration, the means may be the TX processor 468, the RX processor 456, and/or the controller/processor 459 configured to perform the functions recited by the means.

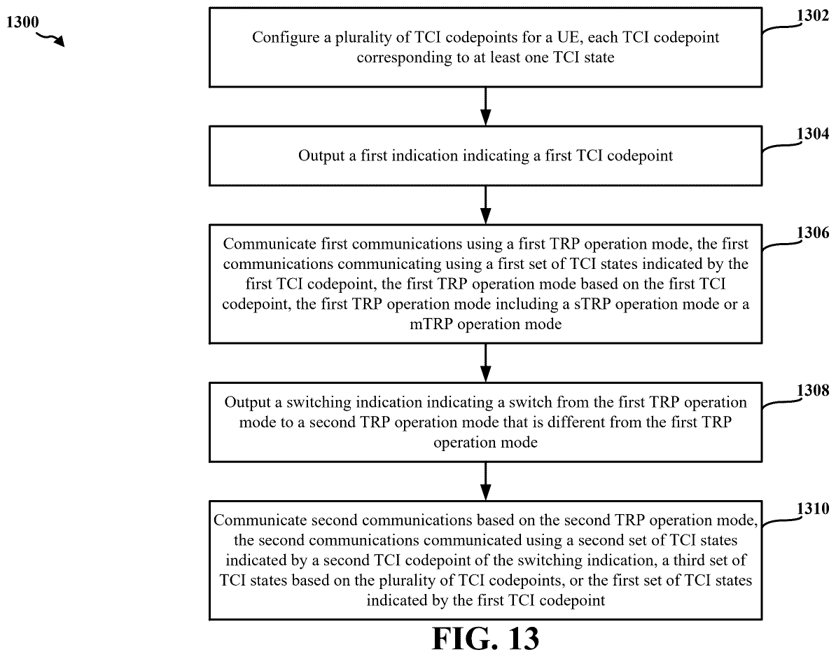

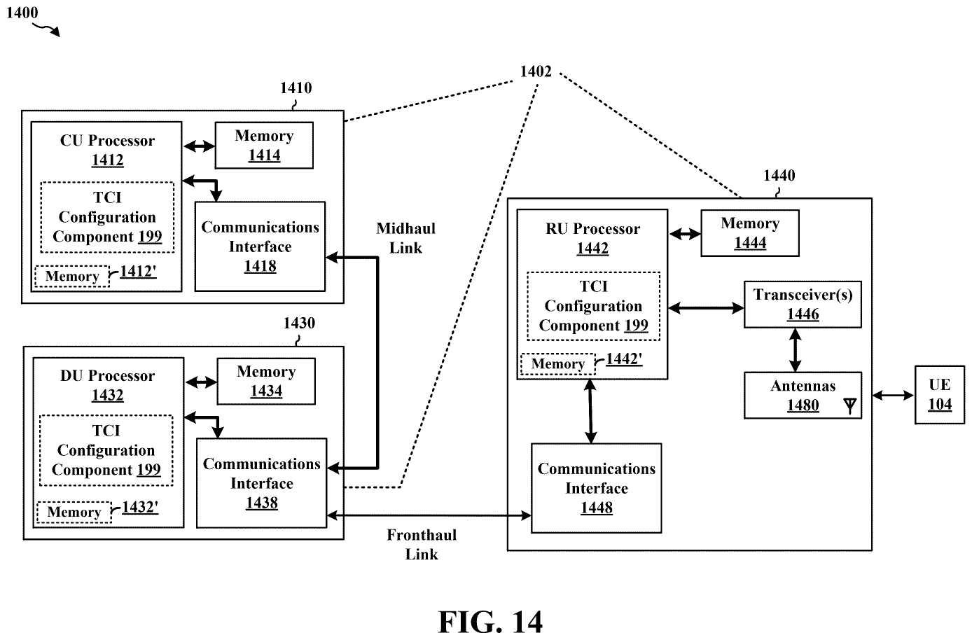

FIG. 13 is a flowchart 1300 of a method of wireless communication. The method may be performed by a network node (e.g., one of the base stations 102, and/or a network entity 1402 of FIG. 14). The method may facilitate applying a default unified TCI rule for periodic or semi-periodic communications after performing a TRP operation mode switch between mTRP operation and sTRP operation.

At 1302, the network node configures a plurality of TCI codepoints for a UE, each TCI codepoint corresponding to at least one TCI state, as described in connection with the configuration 710 of FIG. 7. For example, 1302 may be performed by the TCI configuration component 199 of the network entity 1402 of FIG. 14.

At 1304, the network node outputs a first indication indicating a first TCI codepoint, as described in connection with the first control message 712 and the first TCI codepoint 714 of FIG. 7. For example, 1304 may be performed by the TCI configuration component 199 of the network entity 1402 of FIG. 14.

At 1306, the network node communicates first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode, as described in connection with at least the first communications 718 of FIG. 7. For example, 1306 may be performed by the TCI configuration component 199 of the network entity 1402 of FIG. 14.

At 1308, the network node outputs a switching indication indicating a switch from the first TRP operation mode to a second TRP operation mode that is different from the first TRP operation mode, as described in connection with the switching indicator 720 of FIG. 7. For example, 1308 may be performed by the TCI configuration component 199 of the network entity 1402 of FIG. 14.

At 1310, the network node communicates second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint, as described in connection with the second communications 728 of FIG. 7. For example, 1310 may be performed by the TCI configuration component 199 of the network entity 1402 of FIG. 14.

In some examples, the first TRP operation mode may include the mTRP operation mode, the second TRP operation mode may include the sTRP operation mode, and the first set of TCI states may include two TCI states, as described in connection with the example sequences of FIG. 9.

In some examples, the second communications may be associated with aperiodic occasions, the second TCI codepoint may correspond to a single TCI state, and the second communications may be communicated using the single TCI state of the second set of TCI states, as described in connection with the first sequence 920 of FIG. 9.

In some examples, the second communications may be associated with periodic occasions or semi-periodic occasions, and a target TCI codepoint of the plurality of TCI codepoints may map to two TCI states, as described in connection with the second default unified TCI rule and the third sequence 960 of FIG. 9. The second communications may be communicated using the two TCI states corresponding to the target TCI codepoint.

In some examples, the second communications may be associated with periodic occasions or semi-periodic occasions, and the second communications may be communicated using the two TCI states of the first set of TCI states, as described in connection with the first default unified TCI rule and the second sequence 940 of FIG. 9.

In some examples, the first TRP operation mode may include the sTRP operation mode, the second TRP operation mode may include the mTRP operation mode, and the first set of TCI states may include a single TCI state, as described in connection with the sequences of FIG. 10.

In some examples, the second communications may be associated with aperiodic occasions, the second TCI codepoint may correspond to two TCI states, and the second communications may be communicated using the two TCI states of the second set of TCI states, as described in connection with the first sequence 1020 of FIG. 10.

In some examples, the second communications may be associated with periodic occasions or semi-periodic occasions, where a target TCI codepoint of the plurality of TCI codepoints may map to a single TCI state, as described in connection with the second default unified TCI rule and the third sequence 1060 of FIG. 10. The second communications may be communicated using the single TCI state corresponding to the target TCI codepoint.

In some examples, the second communications may be associated with periodic occasions or semi-periodic occasions, and the second communications may be communicated using the single TCI state of the first set of TCI states, as described in connection with the first default unified TCI rule and the second sequence 1040 of FIG. 10.

In some examples, the network node may output a CORESET configuration including a plurality of CORESETs that are mapping to respective sets of TCI states, where a target CORESET of the plurality of CORESETs corresponds to a single activated TCI state, as described in connection with the configuration 710 of FIG. 7 and the third default unified TCI rule of FIG. 10. The network node may also communicate third communications using the single activated TCI state corresponding to the target CORESET, as described in connection with the third sequence 1060 of FIG. 10.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the TCI configuration component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with one of the UEs 104. The on-chip memories (e.g., the on-chip memory 1412′, the on-chip memory 1432′, and/or the on-chip memory 1442′) and/or the additional memory modules (e.g., the additional memory modules 1414, the additional memory modules 1434, and/or the additional memory modules 1444) may each be considered a computer-readable medium/memory. Each computer-readable medium/memory may be non-transitory. Each of the CU processor 1412, the DU processor 1432, the RU processor 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the TCI configuration component 199 is configured to configure a plurality of TCI codepoints for a UE, each TCI codepoint corresponding to at least one TCI state. The TCI configuration component 199 may also be configured to output a first indication indicating a first TCI codepoint. Additionally, the TCI configuration component 199 may be configured to communicate first communications using a first TRP operation mode, the first communications communicating using a first set of TCI states indicated by the first TCI codepoint, the first TRP operation mode based on the first TCI codepoint, the first TRP operation mode including a sTRP operation mode or a mTRP operation mode. The TCI configuration component 199 may also be configured to output a switching indication indicating a switch from the first TRP operation mode to a second TRP operation mode that is different from the first TRP operation mode. Additionally, the TCI configuration component 199 may be configured to communicate second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

The TCI configuration component 199 may be within one or more processors of one or more of the CU 1410, DU 1430, and the RU 1440. The TCI configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 1402 may include a variety of components configured for various functions. For example, the TCI configuration component 199 may include one or more hardware components that perform each of the blocks of the algorithm in the flowcharts of FIG. 13.

In one configuration, the network entity 1402 includes means for configuring a plurality of transmission code indication (TCI) codepoints for a user equipment (UE), each TCI codepoint corresponding to at least one TCI state. The example network entity 1402 also includes means for outputting a first indication indicating a first TCI codepoint. The example network entity 1402 also includes means for communicating first communications using a first transmit-receipt point (TRP) operation mode, the first communications communicating using a first set of TCI states indicated by the first TCI codepoint, the first TRP operation mode based on the first TCI codepoint, the first TRP operation mode including a single TRP (sTRP) operation mode or a multiple TRP (mTRP) operation mode. The example network entity 1402 also includes means for outputting a switching indication indicating a switch from the first TRP operation mode to a second TRP operation mode that is different from the first TRP operation mode. The example network entity 1402 also includes means for communicating second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

In another configuration, the example network entity 1402 also includes means for outputting a control resource set (CORESET) configuration including a plurality of CORESETs that are mapping to respective sets of TCI states, where a target CORESET of the plurality of CORESETs corresponds to a single activated TCI state. The example network entity 1402 also includes means for communicating third communications using the single activated TCI state corresponding to the target CORESET.

The means may be the TCI configuration component 199 of the network entity 1402 configured to perform the functions recited by the means. As described supra, the network entity 1402 may include the TX processor 416, the RX processor 470, and the controller/processor 475. As such, in one configuration, the means may be the TX processor 416, the RX processor 470, and/or the controller/processor 475 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a configuration configuring a plurality of transmission code indication (TCI) codepoints, each TCI codepoint corresponding to at least one TCI state; receiving a first indication indicating a first TCI codepoint; communicating first communications using a first transmit-receipt point (TRP) operation mode, the first communications communicating using a first set of TCI states indicated by the first TCI codepoint, the first TRP operation mode based on the first TCI codepoint, the first TRP operation mode including a single TRP (sTRP) operation mode or a multiple TRP (mTRP) operation mode; receiving a switching indication indicating a switch from the first TRP operation mode to a second TRP operation mode that is different from the first TRP operation mode; and communicating second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

Aspect 2 is the method of aspect 1, further including that the first TRP operation mode includes the mTRP operation mode, the second TRP operation mode includes the sTRP operation mode, and the first set of TCI states includes two TCI states.

Aspect 3 is the method of any of aspects 1 and 2, further including that the second communications are associated with aperiodic occasions, the second TCI codepoint corresponds to a single TCI state, and the second communications are communicated using the single TCI state of the second set of TCI states.

Aspect 4 is the method of any of aspects 1 and 2, further including that the second communications are associated with periodic occasions or semi-periodic occasions, the method further comprising: identifying a target TCI codepoint of the plurality of TCI codepoints that maps to two additional TCI states, and where the second communications are communicated using the two additional TCI states corresponding to the target TCI codepoint.

Aspect 5 is the method of any of aspects 1 and 2, further including that the second communications are associated with periodic occasions or semi-periodic occasions, and the second communications are communicated using the two TCI states of the first set of TCI states.

Aspect 6 is the method of aspect 1, further including that the first TRP operation mode includes the sTRP operation mode, the second TRP operation mode includes the mTRP operation mode, and the first set of TCI states includes a single TCI state.

Aspect 7 is the method of any of aspects 1 and 6, further including that the second communications are associated with aperiodic occasions, the second TCI codepoint corresponds to two TCI states, and the second communications are communicated using the two TCI states of the second set of TCI states.

Aspect 8 is the method of any of aspects 1 and 6, further including that the second communications are associated with periodic occasions or semi-periodic occasions, the method further comprising: identifying a target TCI codepoint of the plurality of TCI codepoints that maps to an additional single TCI state, and where the second communications are communicated using the additional single TCI state corresponding to the target TCI codepoint.

Aspect 9 is the method of any of aspects 1 and 6, further including that the second communications are associated with periodic occasions or semi-periodic occasions, and the second communications are communicated using the single TCI state of the first set of TCI states.

Aspect 10 is the method of any of aspects 1 and 6, further including: receiving a control resource set (CORESET) configuration including a plurality of CORESETs that are mapping to respective sets of TCI states; identifying a target CORESET of the plurality of CORESETs that maps to a single activated TCI state; and communicating third communications using the single activated TCI state corresponding to the target CORESET.

Aspect 11 is an apparatus for wireless communication at a UE including at least one processor coupled to a memory and configured to implement any of aspects 1 to 10.

In aspect 12, the apparatus of aspect 11 further includes at least one antenna coupled to the at least one processor.

In aspect 13, the apparatus of aspect 11 or 12 further includes a transceiver coupled to the at least one processor.

Aspect 14 is an apparatus for wireless communication including means for implementing any of aspects 1 to 10.

In aspect 15, the apparatus of aspect 14 further includes at least one antenna coupled to the means to perform the method of any of aspects 1 to 10.

In aspect 16, the apparatus of aspect 14 or 15 further includes a transceiver coupled to the means to perform the method of any of aspects 1 to 10.

Aspect 17 is a non-transitory computer-readable storage medium storing computer executable code, where the code, when executed, causes a processor to implement any of aspects 1 to 10.

Aspect 18 is a method of wireless communication at a network node, including: configuring a plurality of transmission code indication (TCI) codepoints for a user equipment (UE), each TCI codepoint corresponding to at least one TCI state; outputting a first indication indicating a first TCI codepoint; communicating first communications using a first transmit-receipt point (TRP) operation mode, the first communications communicating using a first set of TCI states indicated by the first TCI codepoint, the first TRP operation mode based on the first TCI codepoint, the first TRP operation mode including a single TRP (sTRP) operation mode or a multiple TRP (mTRP) operation mode; outputting a switching indication indicating a switch from the first TRP operation mode to a second TRP operation mode that is different from the first TRP operation mode; and communicating second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

Aspect 19 is the method of aspect 18, further including that the first TRP operation mode includes the mTRP operation mode, the second TRP operation mode includes the sTRP operation mode, and the first set of TCI states includes two TCI states.

Aspect 20 is the method of any of aspects 18 and 19, further including that the second communications are associated with aperiodic occasions, the second TCI codepoint corresponds to a single TCI state, and the second communications are communicated using the single TCI state of the second set of TCI states.

Aspect 21 is the method of any of aspects 18 and 19, further including that the second communications are associated with periodic occasions or semi-periodic occasions, and a target TCI codepoint of the plurality of TCI codepoints maps to two additional TCI states, and where the second communications are communicated using the two additional TCI states corresponding to the target TCI codepoint.

Aspect 22 is the method of any of aspects 18 and 19, further including that the second communications are associated with periodic occasions or semi-periodic occasions, and the second communications are communicated using the two TCI states of the first set of TCI states.

Aspect 23 is the method of aspect 18, further including that the first TRP operation mode includes the sTRP operation mode, the second TRP operation mode includes the mTRP operation mode, and the first set of TCI states includes a single TCI state.

Aspect 24 is the method of any of aspects 18 and 23, further including that the second communications are associated with aperiodic occasions, the second TCI codepoint corresponds to two TCI states, and the second communications are communicated using the two TCI states of the second set of TCI states.

Aspect 25 is the method of any of aspects 18 and 23, further including that the second communications are associated with periodic occasions or semi-periodic occasions, where a target TCI codepoint of the plurality of TCI codepoints maps to an additional single TCI state, and where the second communications are communicated using the additional single TCI state corresponding to the target TCI codepoint.

Aspect 26 is the method of any of aspects 18 and 23, further including that the second communications are associated with periodic occasions or semi-periodic occasions, and the second communications are communicated using the single TCI state of the first set of TCI states.

Aspect 27 is the method of any of aspects 18 and 23, further including: outputting a control resource set (CORESET) configuration including a plurality of CORESETs that are mapping to respective sets of TCI states, where a target CORESET of the plurality of CORESETs corresponds to a single activated TCI state; and communicating third communications using the single activated TCI state corresponding to the target CORESET.

Aspect 28 is an apparatus for wireless communication at a network node including at least one processor coupled to a memory and configured to implement any of aspects 18 to 27.

In aspect 29, the apparatus of aspect 28 further includes at least one antenna coupled to the at least one processor.

In aspect 30, the apparatus of aspect 28 or 29 further includes a transceiver coupled to the at least one processor.

Aspect 31 is an apparatus for wireless communication including means for implementing any of aspects 18 to 27.

In aspect 32, the apparatus of aspect 31 further includes at least one antenna coupled to the means to perform the method of any of aspects 18 to 27.

In aspect 33, the apparatus of aspect 31 or 32 further includes a transceiver coupled to the means to perform the method of any of aspects 18 to 27.

Aspect 34 is a non-transitory computer-readable storage medium storing computer executable code, where the code, when executed, causes a processor to implement any of aspects 18 to 27.

What is claimed is:

1. An apparatus for wireless communication at a user equipment (UE), comprising:
memory; and
at least one processor coupled to the memory and configured to:
receive a configuration configuring a plurality of transmission code indication (TCI) codepoints, each TCI codepoint corresponding to at least one TCI state;
receive a first indication indicating a first TCI codepoint;
communicate first communications using a first transmit-receipt point (TRP) operation mode, the first communications communicating using a first set of TCI states indicated by the first TCI codepoint, the first TRP operation mode based on the first TCI codepoint, the first TRP operation mode including a single TRP (sTRP) operation mode or a multiple TRP (mTRP) operation mode;
receive a switching indication indicating a switch from the first TRP operation mode to a second TRP operation mode that is different from the first TRP operation mode; and
communicate second communications based on the second TRP operation mode, the second communications communicated using a second set of TCI states indicated by a second TCI codepoint of the switching indication, a third set of TCI states based on the plurality of TCI codepoints of the configuration, or the first set of TCI states indicated by the first TCI codepoint.

2. The apparatus of claim 1, wherein the first TRP operation mode includes the mTRP operation mode, the second TRP operation mode includes the sTRP operation mode, and the first set of TCI states includes two TCI states.

3. The apparatus of claim 2, wherein the second communications are associated with aperiodic occasions, the second TCI codepoint corresponds to a single TCI state, and the second communications are communicated using the single TCI state of the second set of TCI states.

4. The apparatus of claim 2, wherein the second communications are associated with periodic occasions or semi-periodic occasions, and the at least one processor is further configured to:
identify a target TCI codepoint of the plurality of TCI codepoints that maps to two additional TCI states, and wherein the second communications are communicated using the two additional TCI states corresponding to the target TCI codepoint.

5. The apparatus of claim 2, wherein the second communications are associated with periodic occasions or semi-periodic occasions, and the second communications are communicated using the two TCI states of the first set of TCI states.

6. The apparatus of claim 1, wherein the first TRP operation mode includes the sTRP operation mode, the second TRP operation mode includes the mTRP operation mode, and the first set of TCI states includes a single TCI state.

7. The apparatus of claim 6, wherein the second communications are associated with aperiodic occasions, the second TCI codepoint corresponds to two TCI states, and the second communications are communicated using the two TCI states of the second set of TCI states.

8. The apparatus of claim 6, wherein the second communications are associated with periodic occasions or semi-periodic occasions, and the at least one processor is further configured to:
identify a target TCI codepoint of the plurality of TCI codepoints that maps to an additional single TCI state, and wherein the second communications are communicated using the additional single TCI state corresponding to the target TCI codepoint.

9. The apparatus of claim 6, wherein the second communications are associated with periodic occasions or semi-periodic occasions, and the second communications are communicated using the single TCI state of the first set of TCI states.

10. The apparatus of claim 6, further comprising:
at least one antenna coupled to the at least one processor, wherein the at least one processor is further configured to:
receive a control resource set (CORESET) configuration including a plurality of CORESETs that are mapping to respective sets of TCI states;
identify a target CORESET of the plurality of CORESETs that maps to a single activated TCI state; and
communicate third communications using the single activated TCI state corresponding to the target CORESET.

11. An apparatus for wireless communication at a network node comprising:
memory; and
at least one processor coupled to the memory and configured to:
configure a plurality of transmission code indication (TCI) codepoints for a user equipment (UE), each TCI codepoint corresponding to at least one TCI state;
output a first indication indicating a first TCI codepoint;
communicate first communications using a first transmit-receipt point (TRP) operation mode, the first communications communicating using a first set of TCI states indicated by the first TCI codepoint, the first TRP operation mode based on the first TCI codepoint, the first TRP operation mode including a single TRP (sTRP) operation mode or a multiple TRP (mTRP) operation mode;
output a switching indication indicating a switch from the first TRP operation mode to a second TRP operation mode that is different from the first TRP operation mode; and
communicate second communications based on the second TRP operation mode, the second communications communicated using a second set of TCI states indicated by a second TCI codepoint of the switching indication, a third set of TCI states based on the plurality of TCI codepoints, or the first set of TCI states indicated by the first TCI codepoint.

12. The apparatus of claim 11, wherein the first TRP operation mode includes the mTRP operation mode, the second TRP operation mode includes the sTRP operation mode, and the first set of TCI states includes two TCI states.

13. The apparatus of claim 12, wherein the second communications are associated with aperiodic occasions, the second TCI codepoint corresponds to a single TCI state, and the second communications are communicated using the single TCI state of the second set of TCI states.

14. The apparatus of claim 12, wherein the second communications are associated with periodic occasions or semi-periodic occasions, and a target TCI codepoint of the plurality of TCI codepoints maps to two additional TCI states, and wherein the second communications are communicated using the two additional TCI states corresponding to the target TCI codepoint.

15. The apparatus of claim 12, wherein the second communications are associated with periodic occasions or semi-periodic occasions, and the second communications are communicated using the two TCI states of the first set of TCI states.

16. The apparatus of claim 11, wherein the first TRP operation mode includes the sTRP operation mode, the second TRP operation mode includes the mTRP operation mode, and the first set of TCI states includes a single TCI state.

17. The apparatus of claim 16, wherein the second communications are associated with aperiodic occasions, the second TCI codepoint corresponds to two TCI states, and the second communications are communicated using the two TCI states of the second set of TCI states.

18. The apparatus of claim 16, wherein the second communications are associated with periodic occasions or semi-periodic occasions, wherein a target TCI codepoint of the plurality of TCI codepoints maps to an additional single TCI state, and wherein the second communications are communicated using the additional single TCI state corresponding to the target TCI codepoint.

19. The apparatus of claim 16, wherein the second communications are associated with periodic occasions or semi-periodic occasions, and the second communications are communicated using the single TCI state of the first set of TCI states.

20. The apparatus of claim 16, further comprising:
at least one antenna coupled to the at least one processor, wherein the at least one processor is further configured to:
output a control resource set (CORESET) configuration including a plurality of CORESETs that are mapping to respective sets of TCI states, wherein a target CORESET of the plurality of CORESETs corresponds to a single activated TCI state; and
communicate third communications using the single activated TCI state corresponding to the target CORESET.
